(19) United States
(12) Patent Application Publication
(10) Pub. No.: US 2006/0041627 A1
(43) Pub. Date: Feb. 23, 2006

(54) System and method for effectively exchanging photo data in an instant messaging environment

(75) Inventor: Edgar A. Tu, Castro Valley, CA (US)

Correspondence Address: Gregory J. Koerner;Redwood Patent Law, 1291 East Hillsdale Boulevard, Suite 205, Foster City, CA, 94404, US

(73) Assignee: Sony Computer Entertainment America Inc.

(21) Appl. No.: 10/922,693

(22) Filed: Aug. 20, 2004

(51) Int. Cl. G06F 15/16

(52) U.S. Cl. 709/206

(57) ABSTRACT

A system and method for effectively exchanging photo data in an instant messaging environment includes a first device coupled to an electronic network for utilizing a first messaging program and a first messaging display to create text messages for performing messaging procedures. A photo data source such as a digital camera is configured to capture photo data when the first device is instructed to transmit the text messages by activating a “send message” icon on the first messaging display. The first messaging program automatically creates and transmits photo messages that include the photo data and corresponding text messages. A second device coupled to the electronic network may then utilize a second messaging program to receive and display the text messages and photo data from the transmitted photo messages upon a second messaging display. The second device may also similarly create and send reciprocal photo messages to the first device during the foregoing messaging procedures.

### BACKGROUND SECTION

1. Field of the Invention

This invention relates generally to techniques for exchanging electronic information, and relates more particularly to a system and method for effectively exchanging photo data in an instant messaging environment.

2. Description of the Background Art

Implementing effective methods for exchanging electronic information is a significant consideration for designers and manufacturers of contemporary electronic devices. However, effectively exchanging information between devices in an electronic network may create substantial challenges for system designers. For example, enhanced demands for increased device functionality and performance may require more system processing power and require additional software resources. An increase in processing or software requirements may also result in a corresponding detrimental economic impact due to increased production costs and operational inefficiencies.

Furthermore, enhanced device capability to perform various advanced information exchange operations may provide additional benefits to a system user, but may also place increased demands on the control and management of various system components. For example, an enhanced electronic network device that effectively exchanges digital image data may frequently benefit from an efficient implementation because of the large amount and complexity of the digital data involved.

Designing electronic devices that provide various types of enhanced device functionality while still maintaining a sufficient level of user-friendliness and ease-of-operation is another significant consideration when implementing electronic devices for use in certain environments in which the relative level of technical sophistication of device users is not particularly high. In addition, various types of streamlined and automated functionalities may frequently be beneficial in order to allow device users to advantageously utilize their time and energy for performing other productive tasks.

Due to growing demands on system resources and substantially increasing data magnitudes, it is apparent that developing new techniques for exchanging information in an electronic network is a matter of concern for related electronic technologies. Therefore, for all the foregoing reasons, developing effective systems for exchanging information in an electronic network remains a significant consideration for designers, manufacturers, and users of contemporary electronic devices.

### SUMMARY

In accordance with the present invention, a system and method for effectively exchanging photo data in an instant messaging environment are disclosed. In one embodiment, a first device and a second device initially perform log-in procedures to participate in a messaging session through an electronic network. A first device user of the first device may compose a text message for transmitting to the second device. Then, the first device user activates a “send message” icon on a first messaging display of the first device to instruct the first device to transmit the text message over the electronic network.

In response to activating the “send message” icon, a photo data source (such as a digital camera) coupled to the first device captures selected photo data, and provides the captured photo data to a first messaging program of the first device. The first messaging program then transmits the text message and the captured photo data to the second device as a photo message. The first messaging display may also display the transmitted photo message to facilitate the messaging session.

A second messaging program from the second device may then receive the photo message transmitted from the first device, and may display the photo data and corresponding text message from the photo message on a second messaging display of the second device. The second device may then create and transmit a reciprocal photo message to the first device using the same or similar techniques to those discussed above in conjunction with the photo message from the first device. The messaging procedure may thus continue with photo messages being exchanged between the first device and the second device until one or both of the devices perform a log-off procedure to terminate the messaging session.

The present invention therefore provides an effective technique for exchanging photo data in an instant messaging environment. Transmitting the photo data as part of a photo message allows messaging partners to enjoy certain visual benefits of exchanged image data without the significant system resources (such as processing power, memory capacity, and communications bandwidth) required to support video conferencing. System users may utilize the present invention to exchange photos of themselves as they transmit each text message to thereby augment the entertainment value and increase communication quality during messaging sessions. The present invention may also be effectively utilized to facilitate conferences or meetings between remote parties by providing an economical means for exchanging drawings, documents, or other visual information. The present invention thus provides a streamlined, efficient, and user-friendly mechanism for exchanging photo data between messaging devices in an instant messaging environment.

### BRIEF DESCRIPTION OF THE DRAWINGS

FIG. 1 is a block diagram of an electronic network, in accordance with one embodiment of the present invention;

FIG. 2 is a block diagram for one embodiment of a device of FIG. 1, in accordance with the present invention;

FIG. 3 is a block diagram for one embodiment of an entertainment system, in accordance with the present invention;

FIG. 4 is a block diagram for one embodiment the memory of FIG. 2, in accordance with the present invention;

FIG. 5 is a block diagram for one embodiment the broadband navigator of FIG. 4, in accordance with the present invention;

FIG. 6 is a block diagram for one embodiment of messaging session data, in accordance with the present invention;

FIG. 7 is a block diagram for one embodiment of a photo message, in accordance with the present invention;

FIG. 8 is a diagram of a messaging display, in accordance with one embodiment of the present invention;

FIG. 9 is a flowchart of method steps for performing a photo message transmission procedure, in accordance with one embodiment of the present invention;

FIG. 10 is a flowchart of method steps for performing a photo message reception procedure, in accordance with one embodiment of the present invention; and

FIG. 11 is a block diagram illustrating a split transmission technique, in accordance with one embodiment of the present invention.

### DETAILED DESCRIPTION

The present invention relates to an improvement in electronic information exchange techniques. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for effectively exchanging photo data in an instant messaging environment, and includes a first device coupled to an electronic network for utilizing a first messaging program and a first messaging display to create text messages for performing messaging procedures. A photo data source such as a digital camera is configured to capture photo data when the first device is instructed to transmit the text messages by activating a “send message” icon on the first messaging display. The first messaging program automatically creates and transmits photo messages that include the photo data and corresponding text messages. A second device coupled to the electronic network may then utilize a second messaging program to receive and display the text messages and photo data from the transmitted photo messages upon a second messaging display. The second device may also similarly create and send reciprocal photo messages to the first device during the foregoing messaging procedures.

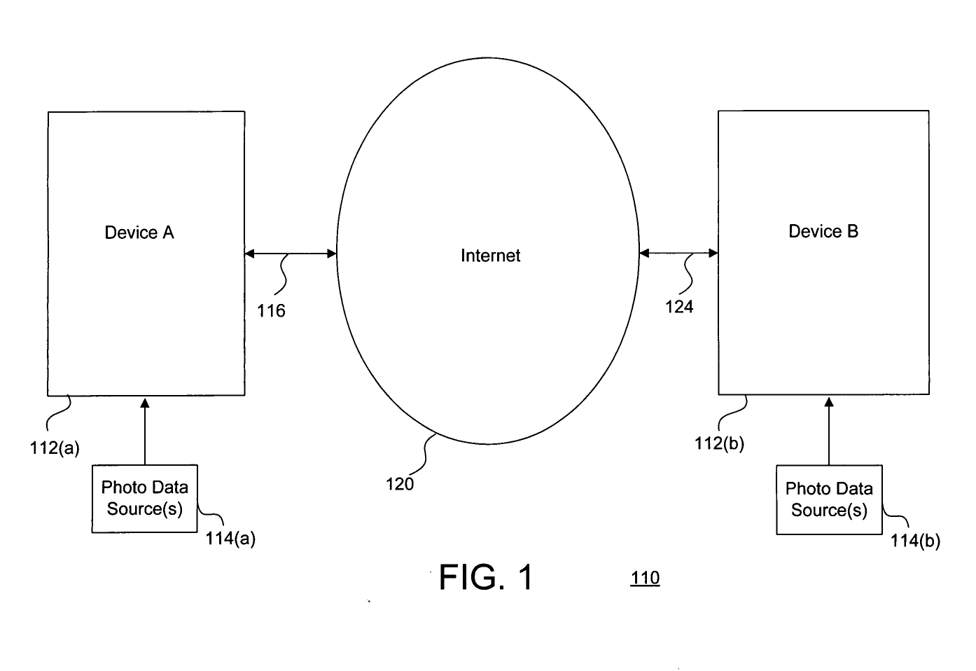

Referring now to FIG. 1, a block diagram of an electronic network 110 is shown, in accordance with one embodiment of the present invention. In the FIG. 1 embodiment, electronic network 110 may include, but is not limited to, a device A 112(a), a device B 112(b), one or more photo data sources 114(a), one or more photo data sources 114(b), and an Internet 120. In alternate embodiments, electronic network 110 may readily be implemented using various components and configurations in addition to, or instead of, those discussed in conjunction with the FIG. 1 embodiment. For example, electronic network 110 may be implemented to include any desired number of devices 112 with corresponding photo data sources 114.

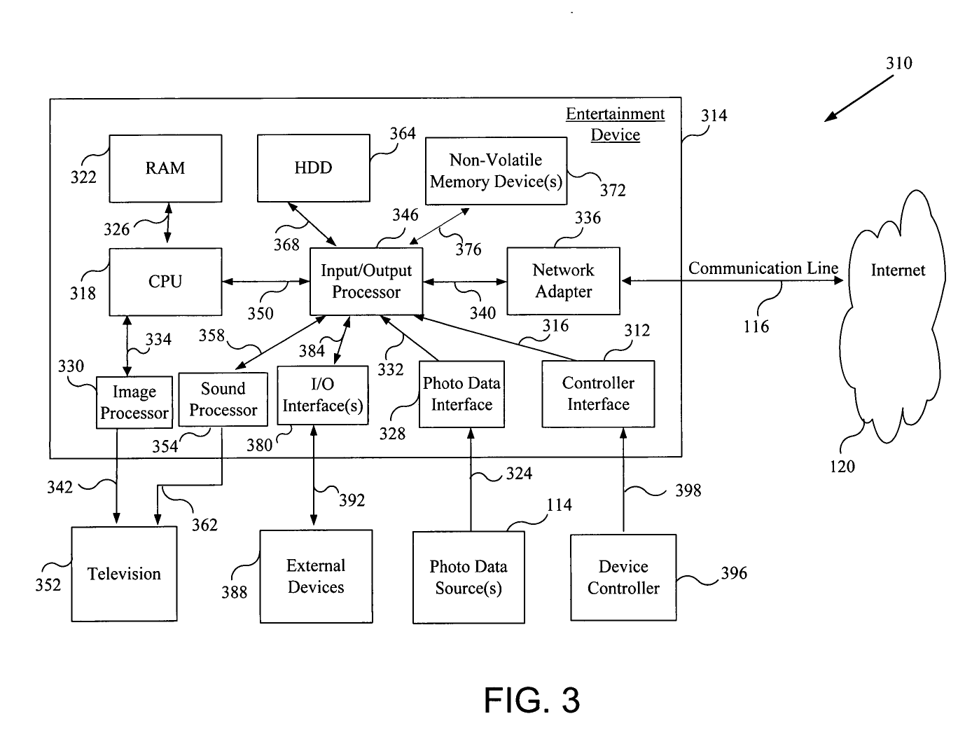

In the FIG. 1 embodiment, device A 112(a) and device B 112(b) may be implemented as any type of appropriate electronic devices. For example, in certain embodiments, device A 112(a) and device B 112(b) may be implemented as stationary or portable consumer-electronics entertainment devices, as further discussed below in conjunction with FIG. 3. In the FIG. 1 embodiment, device A 112(a) and device B 112(b) may utilize respective messaging software to communication through Internet 120.

In the FIG. 1 embodiment, photo data source(s) 114(a) and 114(b) may include any appropriate sources of photo data. For example, photo data source(s) 114 may include, but are not limited to, various types of electronic camera devices that may capture photo data either locally or remotely. In certain embodiments, photo data source(s) may also include other electronic devices capable of either capturing or storing photo data for subsequently downloading to device A 112(a) or device B 112(b). For example, photo data source(s) 114 may include, but are not limited to, a camcorder (a portable video camera with built-in recorder), a digital camera device, an audio-related electronic device, or a webcam device that is configured to capture and provide photographic image data to a distributed computer network such as the Internet. In addition, in accordance with the present invention, device A 112(a) and device B 112(b) may receive or access any other desired type of data for performing a photo data exchange procedure. The concepts and principles of the present invention are therefore not limited to exchanging image data, but may readily be applied to any other type of electronic information.

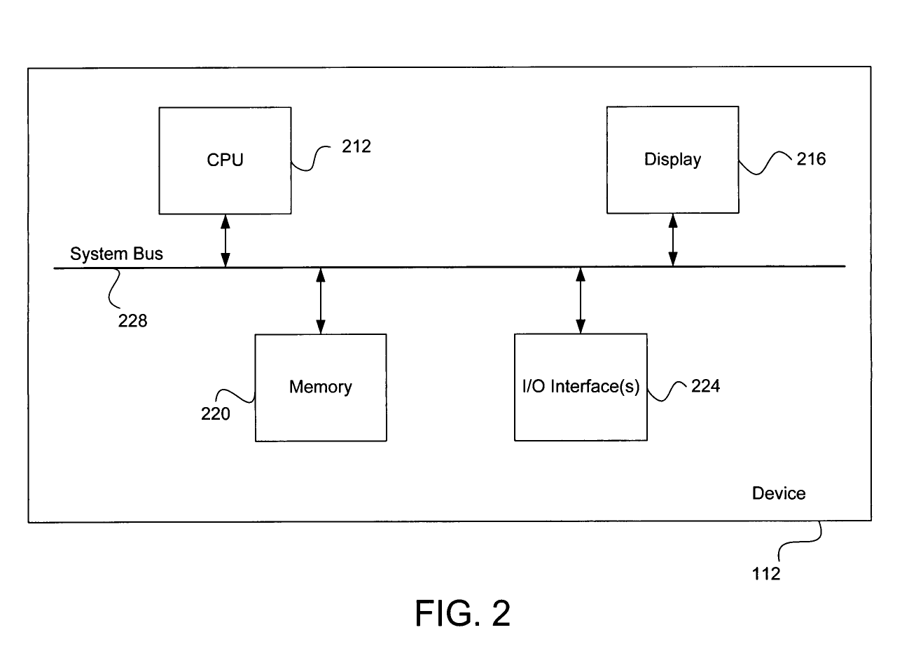

In accordance with the present invention, device A 112(a) and device B 112(b) may automatically exchange the foregoing photo data. In certain embodiments, Internet 120 may be implemented as any other type of distributed electronic network including, but not limited to, an intranet configuration. Furthermore, in other embodiments, device A 112(a) and device B 112(b) may alternately communicate directly with each other using appropriate peer-to-peer communication techniques. The implementation and utilization of network 110 is further discussed below in conjunction with FIG. 2 through FIG. 10.

Referring now to FIG. 2, a block diagram for one embodiment of the FIG. 1 devices 112 is shown, in accordance with the present invention. In the FIG. 2 embodiment, a device 112 may include, but is not limited to, a central processing unit (CPU) 212, a display 216, a memory 220, and one or more input/output interface(s) (I/O interface(s)) 224. The foregoing components of device 112 may be coupled to, and communicate through, a system bus 228. In alternate embodiments, device 112 may readily be implemented using various components and configurations in addition to, or instead of, those discussed in conjunction with the FIG. 2 embodiment.

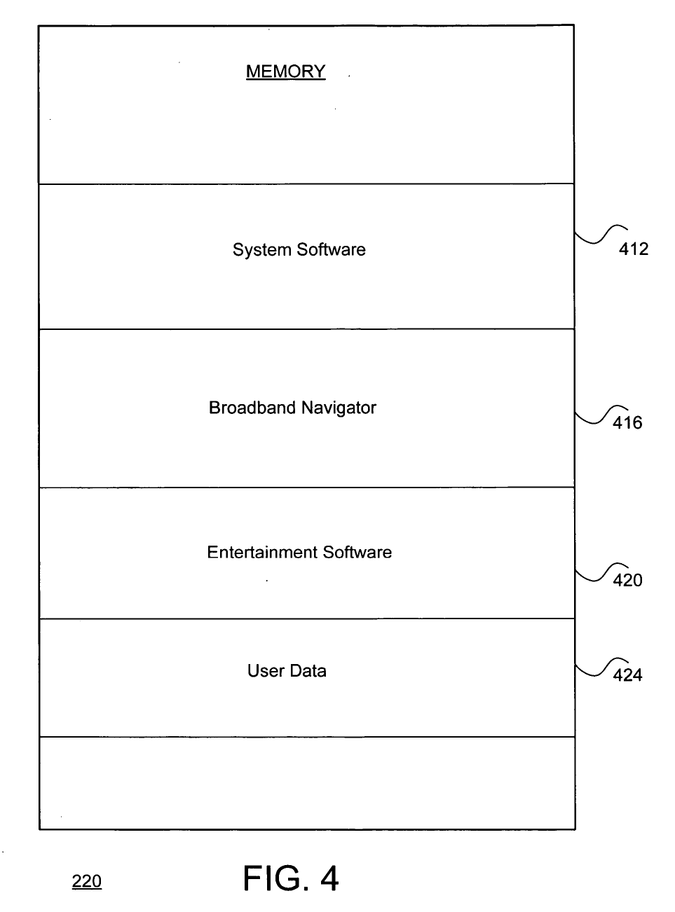

In the FIG. 2 embodiment, CPU 212 may be implemented to include any appropriate and compatible microprocessor device that preferably executes software instructions to thereby control and manage the operation of device 112. The FIG. 2 display 216 may include any effective type of display technology including a cathode-ray-tube monitor or a liquid-crystal display device with an appropriate screen for displaying various information to a device user. In the FIG. 2 embodiment, memory 220 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of memory 220 are further discussed below in conjunction with FIG. 4.

In the FIG. 2 embodiment, I/O interface(s) 224 may include one or more input and/or output interfaces to receive and/or transmit any required types of information by device 112. I/O interfaces(s) 224 may include one or more means for allowing a device user to communicate with device 112. For example, the foregoing means may include a keyboard device, a wireless remote-control device, a speech-recognition module with corresponding microphone, a graphical user interface with touch-screen capability, a hand-held device controller unit, or a selection button array mounted externally on device 112. In addition, a microphone device for recording audio information may be coupled to device 112 through I/O interfaces 224.

Referring now to FIG. 3, a block diagram for one embodiment of an entertainment system 310 is shown, in accordance with certain embodiments of the present invention. The FIG. 3 entertainment system 310 may include, but is not limited to, one or more photo data source(s) 114, an entertainment device 314, a television 352, and at least one device controller 396. In alternate embodiments, entertainment system 310 may readily be implemented using various components, functionalities, and configurations in addition to, or instead of, those discussed in conjunction with the FIG. 3 embodiment.

In accordance with various embodiments of the present invention, entertainment device 314 may be implemented in any effective and appropriate manner. For example, in certain embodiments, entertainment device 314 may be effectively implemented as a Sony PlayStation® device. Furthermore, in certain embodiments of the present invention, either or both of device A 112(a) and device B 112(b) that are shown and discussed in conjunction with foregoing FIG. 1 may be implemented and configured in a same or similar manner to that shown herein for entertainment device 314 of FIG. 3. In addition, certain elements or functionalities of the present invention may readily be embodied as part of an electronic console device or an electronic appliance.

In the FIG. 3 embodiment, entertainment device 314 may include a input/output processor (IOP) 346 that coordinates transfers of various types of information for entertainment device 314. In the FIG. 3 embodiment, IOP 346 may communicate with a central processing unit (CPU) 318 via path 350. In addition, IOP 346 may communicate with a hard disk drive (HDD) 364 via path 368, and with various types of non-volatile memory devices 372 via path 376. In the FIG. 3 embodiment, non-volatile memory devices 372 may include, but are not limited to, compact disks, memory sticks, and floppy disks.

In the FIG. 3 embodiment, IOP 346 may also communicate with various external devices 388 via path 384, I/O interfaces 380, and path 392. External devices 388 may include any appropriate electronic entities that may be coupled to entertainment device 314. For example, in certain embodiments, external devices 388 may include various types of electronic devices that support an IEEE 1394 interconnectivity standard, or a Universal Serial Bus (USB) standard. In the FIG. 3 embodiment, a device user of entertainment system 310 may exchange various types of control and user-interface communications with IOP 346 of entertainment device 314 by utilizing device controller 396 via path 398, controller interface 312, and path 316.

In the FIG. 3 embodiment, CPU 318 may communicate with random-access memory (RAM) 322 via path 326 to temporarily store or access various types of electronic information. In the FIG. 3 embodiment, CPU 318 may also provide various types of image data to television 352 via path 334, image processor 330, and path 342 for viewing by a device user of entertainment system 310. Similarly, IOP 346 may provide various types of sound data to television 352 via path 358, sound processor 354, and path 362 for use by the foregoing device user of entertainment system 310.

In the FIG. 3 embodiment, photo data source(s) 114 may provide various types of photo data to IOP 346 via path 324, photo data interface 328, and path 332. Photo data source(s) 114 may include any appropriate source of photo data in any desired and supported format. For example, photo data source(s) 114 may include, but are not limited to, various types of electronic camera devices that may capture photo data either locally or at a remote location. In certain embodiments, photo data source(s) 114 may also include other types of stationary or portable electronic devices capable of either capturing or storing photo data for subsequently downloading to entertainment device 314 by utilizing either hard-wired or wireless techniques.

Digital camera devices such as photo data source 114 and electronic gaming devices such as entertainment device 314 have traditionally been stand-alone off-line devices. Certain embodiments of the present invention effectively combine functionalities of photo data source 114 and entertainment device 314 in an on-line networked environment to support an automatic streamlined distribution model for various appropriate types of electronic information.

In the FIG. 3 embodiment, entertainment device 314 may perform various communications with Internet 120 via IOP 346, path 340, network adapter 336, and communication line 116. In alternate embodiments, Internet 120 may be implemented as any other type of distributed electronic network including, but not limited to, an intranet configuration. Furthermore, in other embodiments, a device 112 (such as the entertainment device 314 of FIG. 3) may alternately communicate directly with other devices 112 using appropriate peer-to-peer communication techniques.

Referring now to FIG. 4, a block diagram for one embodiment of the FIG. 2 memory 220 is shown, in accordance with the present invention. In the FIG. 4 embodiment, memory 220 preferably includes, but is not limited to, system software 412, a broadband navigator 416, entertainment software 420, and user data 424. In alternate embodiments, memory 220 may readily include various other components in addition to, or instead of, those components discussed in conjunction with the FIG. 4 embodiment.

In the FIG. 4 embodiment, system software 412 may include program instructions that are executed by CPU 212 (FIG. 2) to perform various functions and operations for device 112. The particular nature and functionality of system software 412 typically varies depending upon factors such as the specific type and particular functionality of the corresponding device 112.

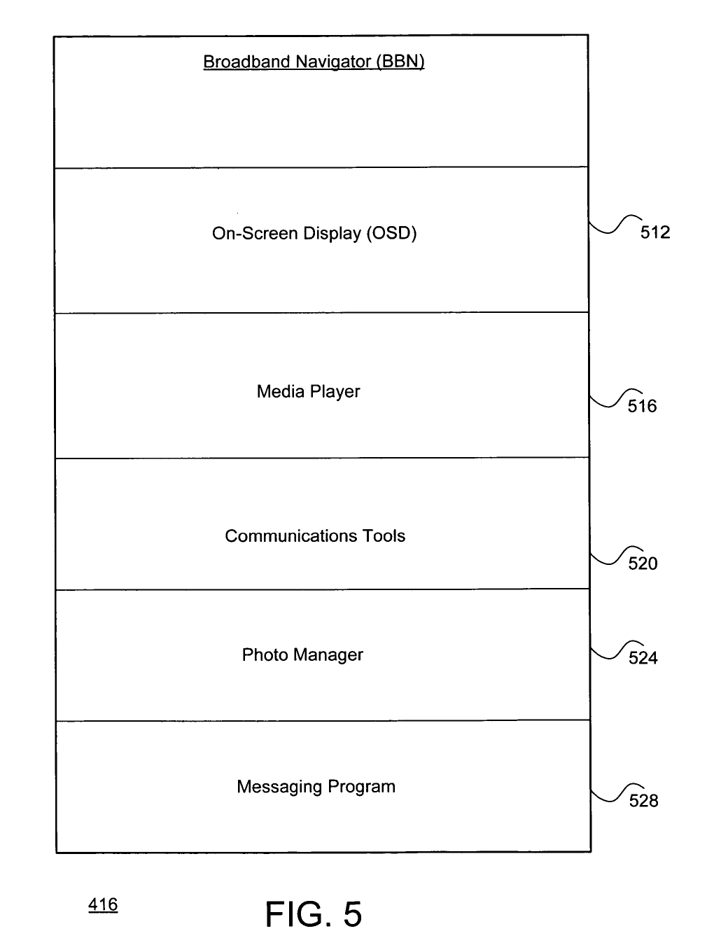

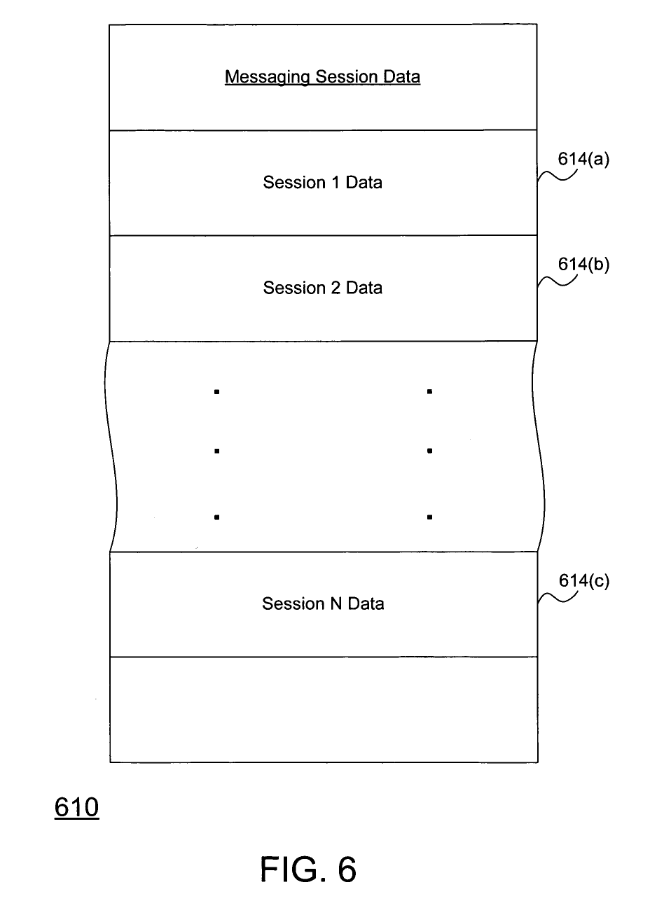

In the FIG. 4 embodiment, device 112 may utilize broadband navigator 416 to perform various control and communication functions for device 112. One embodiment for implementing broadband navigator 416 is further discussed below in conjunction with FIG. 5. In certain embodiments, various elements or functionalities of broadband navigator 416 may readily be embodied as part of an electronic console device or an electronic appliance. In the FIG. 4 embodiment, entertainment software 420 may include any appropriate types of software and other related information for performing various entertainment functions for device 112. For example, entertainment software 420 may include any desired number of computer gaming programs and associated gaming data. In the FIG. 4 embodiment, user data 424 may include any appropriate information for use by device 112. For example, user data 424 may include, but is not limited to, messaging session data corresponding to one or more instant messaging sessions between devices 112 in electronic network 110. One embodiment for implementing message session data is further discussed below in conjunction with FIG. 6.

Referring now to FIG. 5, a diagram for one embodiment of the FIG. 4 broadband navigator 416 is shown, in accordance with the present invention. In the FIG. 5 embodiment, broadband navigator 416 may include, but is not limited to, an on-screen display module (OSD) 512, a media player 516, communication tools 520, a photo manager 524, and a messaging program 528. In alternate embodiments, broadband navigator 416 may readily include various other elements and functionalities in addition to, or instead of, those elements and functionalities discussed in conjunction with the FIG. 5 embodiment.

In the FIG. 5 embodiment, device 112 may utilize OSD 512 to provide various types of displays and user interfaces on display 216 (FIG. 2). For example, OSD 512 may provide various user interfaces for specifying system settings for device 112. In the FIG. 5 embodiment, device 112 may utilize media player 516 to reproduce various types of media on device 112. For example, media play 516 may reproduce video and/or audio data on device 112. In the FIG. 5 embodiment, communication tools 520 may include any appropriate programs, data, or other components for performing corresponding communications functions with device 112.

In the FIG. 5 embodiment, device 112 may advantageously utilize photo manager 524 to capture photo data from one or more photo data source(s) (FIG. 1) and automatically exchange the captured photo data with one or more designated devices 112 in electronic network 110 (FIG. 1). In addition, the other devices 112 in electronic network 110 may utilize a similar photo manager 524 to automatically receive and handle the foregoing photo data. Photo manager 524 may also be utilized to manage photo data in any other desired manner.

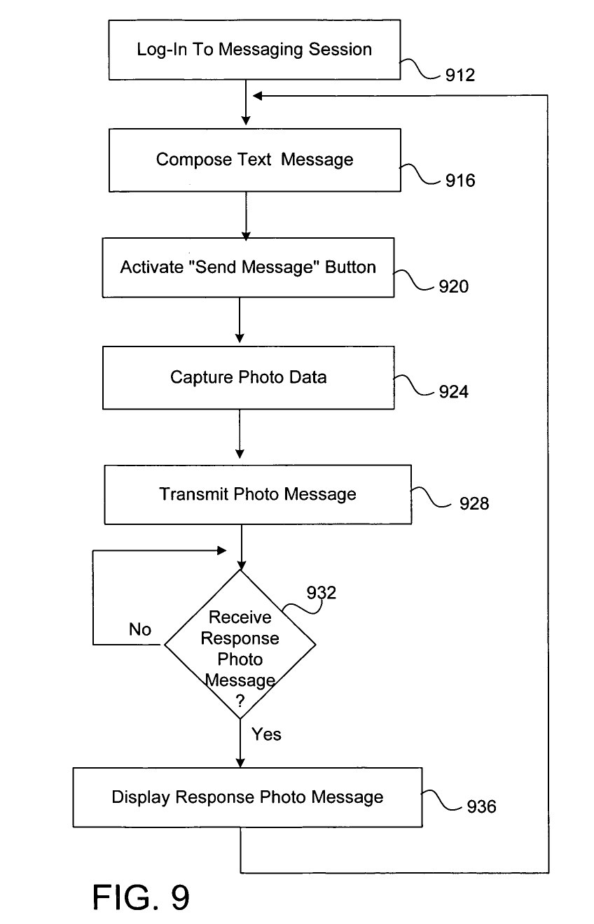

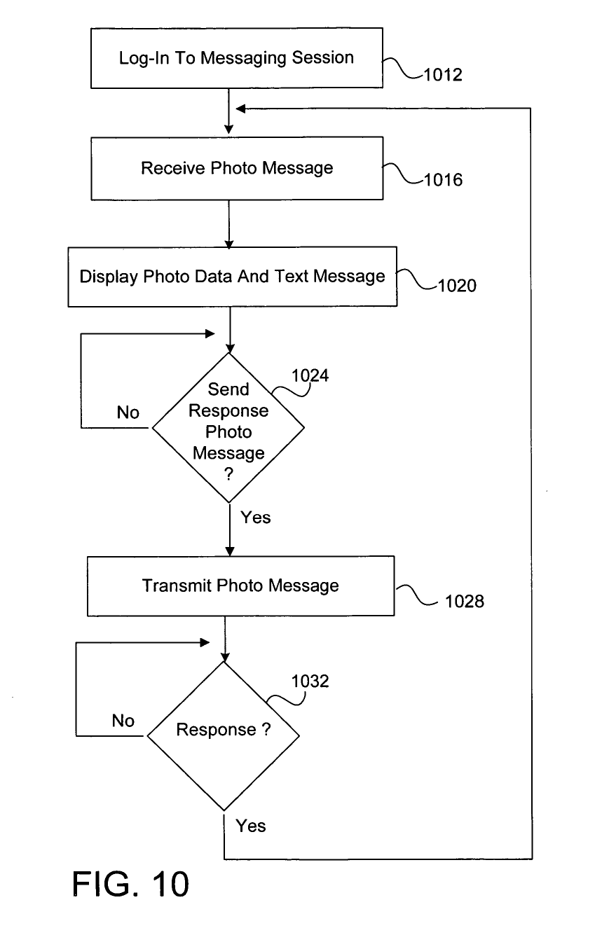

In the FIG. 5 embodiment, device 112 may utilize messaging program 528 to create and exchange various types of electronic messages from device 112 to other designated devices 128 in electronic network 110 during instant messaging sessions. In addition, the other devices 112 in electronic network 110 may utilize a similar messaging program 528 to receive the foregoing electronic messages. The utilization and functionality of messaging program 528 is further discussed below in conjunction with FIGS. 9-10.

Referring now to FIG. 6, a diagram for one embodiment of messaging session data 610 is shown, in accordance with the present invention. In the FIG. 6 embodiment, messaging session data 610 may include, but is not limited to, session 1 data 1 614(a) through session N data N 614(c). In alternate embodiments, messaging session data 610 may readily include various other elements and in addition to, or instead of, those elements and configurations discussed in conjunction with the FIG. 6 embodiment.

In the FIG. 6 embodiment, session data 1 614(a) through session data N 614(c) may each include a series of digital images corresponding to electronic photographs captured by a photo data source 128 (FIG. 1) during respective instant messaging sessions. In certain embodiments, the foregoing series of digital images may be viewed in succession as a form of slide show or moving picture to represent the entire corresponding messaging session. In addition, in certain embodiments, session data 1 614(a) through session data N 614(c) may each include various types of ancillary data associated with the corresponding digital images. For example, the foregoing ancillary data may include, but is not limited to, text messages 718, an image capture date and time, an image capture location, image format information, and various types of user-generated image annotation information.

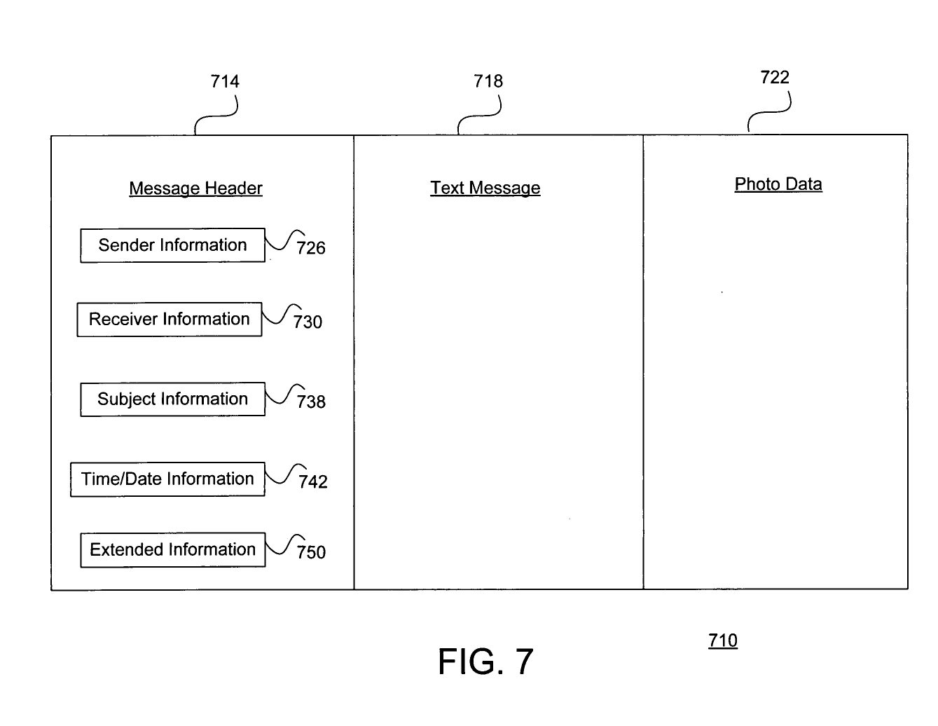

Referring now to FIG. 7, a diagram for one embodiment of a photo message 710 is shown, in accordance with the present invention. In the FIG. 7 embodiment, photo message 710 may include, but is not limited to, a message header 714, a text message 718, and photo data 722. In alternate embodiments, photo message 710 may readily include various other elements and functionalities in addition to, or instead of, those elements and functionalities discussed in conjunction with the FIG. 7 embodiment. For example, in certain embodiments, photo message 710 may also include audio information corresponding to text message 718.

In the FIG. 7 embodiment, a messaging program 528 of a device 112 may automatically create photo message 710 after a device user enters text message 718, and a photo data source 114 (FIG. 1) captures photo data 722 in response to the device user activating a “send message” icon on a messaging display of the device 112. In certain messaging environments, photo data 722 may include a current image of the device user's face captured contemporaneously with the sending of photo message 710. Alternately, photo data 722 may include any other desired subject matter. For example, drawings or images of various objects may be exchanged. In the FIG. 7 embodiment, message header 714 may include, but is not limited to, sender information 726 to identify a message sender of photo message 710, receiver information 730 to identify a message target for photo message 710, subject information to identify the particular messaging session, and time/date information 742 to indicate the date and the time that photo message 710 was created. In the FIG. 7 embodiment, extended information 750 may include any appropriate type of additional information associated with the corresponding photo message 710. For example, extended information 750 may include information for cataloguing, organizing, or identifying corresponding photo data 722. The utilization and implementation of photo message 710 are further discussed below in conjunction with FIGS. 9-10.

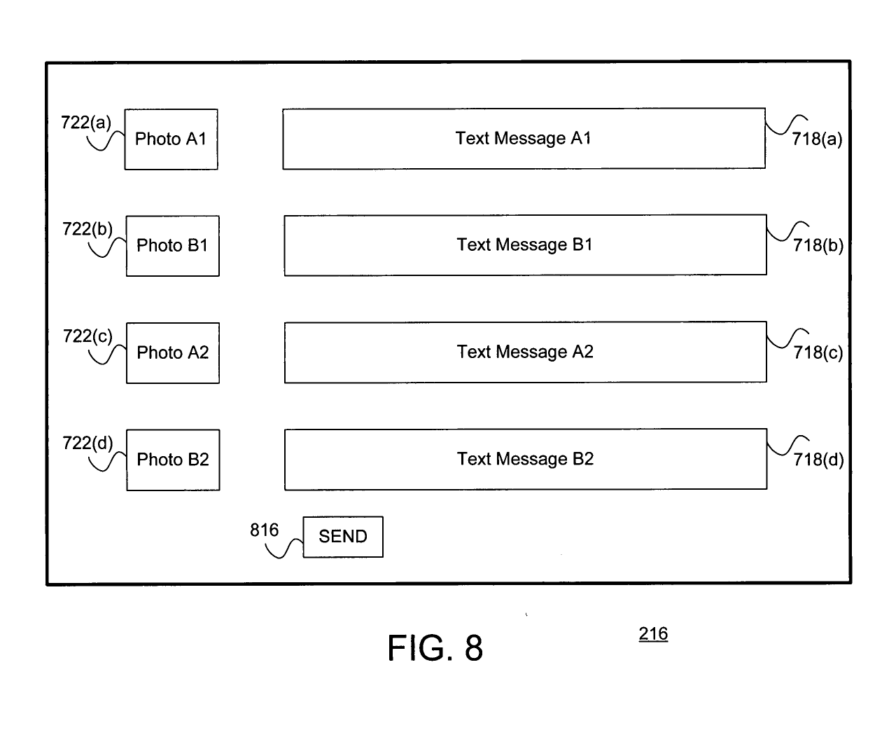

Referring now to FIG. 8, a diagram for one embodiment of a messaging display 216 is shown, in accordance with the present invention. The FIG. 8 example is presented for purposes of illustration, and in alternate embodiments, messaging display 216 may readily include various other components and functionalities in addition to, or instead of, certain of those components and functionalities discussed in conjunction with the FIG. 8 embodiment. For example, the FIG. 8 example includes four text messages 718 with corresponding respective photos 722, however, in other embodiments, display 216 may present any number of messages 718 and photos 722.

In the FIG. 8 embodiment, display 216 includes a text message Al 718(a), a text message B1 718(b), a text message A2 718(c), and a text message B2 718(d). In the FIG. 8 embodiment, text message A1 718(a) is associated with a photo A1 722(a), text message B2 718(b) is associated with a photo B1 722(b), text message A2 718(c) is associated with a photo A2 722(c), and text message B2 is associated with a photo B2 722(d). In various other embodiments, photos 722 may be located in any other desired location on messaging display 216. For example, in certain embodiments, photos 722 may be positioned to the right of corresponding text messages 718.

In the FIG. 8 embodiment, during an instant messaging session between a device A 112(a) and a device B 112(b) (see FIG. 1), text message Al 718(a) may initially be prepared by a device user of a device A 112(a) (FIG. 1) by utilizing a messaging program 528 and a messaging display 216 of device A 112(a). When the device user of device A 112(a) is ready to transmit text message A1 718(a) to device B 112(b), then the device user of device A 112(a) may activate the “send message” icon (SEND) 816 on messaging display 216.

In response, a photo manager 524 of device A 112(a) may capture photo A1 722(a) from photo data source 114(a) (FIG. 1), and the messaging program 528 of device A 112(a) may transmit text message A1 718(a) and photo A1 722(a) to device B 112(b) as a photo message 710, as discussed above in conjunction with FIG. 7. In certain embodiments, devices 112 may capture photo data 722 with photo data source 114 in advance of when the “send message” icon is activated on messaging display 216. In addition, in certain embodiments, the present invention may support a preview mode on a sending device 112 during which a live preview image from photo data source 114 is displayed on messaging display 216 to facilitate accurately framing and capturing photos 722.

A messaging program 528 of device B 112(b) may then receive the photo message 710 from device A 112(a), and may display the received text message A1 718(a) and corresponding photo A1 722(a) upon a messaging display 216 of device B 112(b). A corresponding version of the photo message 710 is concurrently presented in a similar position on the messaging display 216 of sending device A 112(a) to facilitate the messaging session between device A 112(a) and device B 112(b).

In the FIG. 8 example, device B 112(b) may then assume the role of sending device, and may create and send a response photo message 710 to device A 112(a) including text message B1 718(b) and photo B1 722(b). The messaging session may then continue with device A 112(a) sending text message A2 718(c) and photo A2 722(c) to device B 112(b), and with device B 112(b) sending text message B2 718(d) and photo B2 722(d) to device A 112(a). In the FIG. 8 embodiment, new text messages 718 and corresponding photos 722 thus appear at the bottom of messaging display 216, while the oldest text messages 718 and corresponding photos 722 are scrolled off the top of messaging display 216 to create addition viewing space on messaging display 216.

In certain embodiments, various other sequences and viewing orders are possible for presenting text messages 718 and photos 722. For example, in certain embodiments, new text messages 718 and corresponding photos 722 may be inserted at the top of messaging screen 216, while the oldest text messages 718 and corresponding photos 722 are scrolled off the bottom of messaging display 216 to create addition viewing space.

The present invention therefore provides an effective technique for exchanging photo data in an instant messaging environment. Transmitting the photo data 722 as part of a photo message 710 allows messaging partners to enjoy certain visual benefits of exchanged image data without the significant system resources (such as processing power, memory capacity, and communications bandwidth) required to support video conferencing. System users may utilize the present invention to exchange photos 722 of themselves as they transmit each text message 718 to thereby augment the entertainment value and increase communication quality during messaging sessions. The present invention may also be effectively utilized to facilitate conferences or meetings between remote parties by providing an economical means for exchanging drawings, documents, or other visual information. Certain embodiments for performing instant messaging procedures are discussed below in conjunction with FIGS. 9 and 10.

Referring now to FIG. 9, a flowchart of method steps for performing a photo message transmission procedure is shown, in accordance with one embodiment of the present invention. The FIG. 9 example is presented for purposes of illustration, and in alternate embodiments, the present invention may readily utilize steps and sequences other than certain of those discussed in conjunction with the FIG. 9 embodiment.

In accordance with the present invention, in step 912, a first device A 112(a) initially performs a log-in procedure to participate in a messaging session with a second device B 112(b) through an electronic network 110 (FIG. 1). In step 916, a first device user of device A 112(a) composes a first text message 718 for transmitting to the second device B 112(b). Then, in step 920, the first device user activates a “send message” button 816 on a messaging display 216 of device A 112(a).

In step 924, a photo data source 114(a) coupled to device A 112(a) captures photo data 722, and provides the captured photo data 722 to a messaging program 528 of device A 112(a). In step 928, the messaging program 528 of device A 112(a) transmits the text message 718 and the captured photo data 722 to device B 112(b) as a photo message 710. The messaging display 216 of device A 112(a) may also display the transmitted photo message 710 to facilitate the messaging session. In step 932, device A 112(a) waits for a response photo message 710 from device B 112(b). In step 936, when a response photo message 710 from device B 112(b) is received, then the FIG. 9 process may return to step 916 to create and send another photo message 710 to device B 112(b). The FIG. 9 messaging session may thus continue with photo messages being exchanged between device A 112(a) and device B 112(b) until one or both of the devices 112 perform a log-off procedure to terminate the messaging session.

Referring now to FIG. 10, a flowchart of method steps for performing a photo-message reception procedure is shown, in accordance with one embodiment of the present invention. The FIG. 10 example is presented for purposes of illustration, and in alternate embodiments, the present invention may readily utilize steps and sequences other than certain of those discussed in conjunction with the FIG. 10 embodiment.

In accordance with the present invention, in step 1012, a second device B 112(b) initially performs a log-in procedure to participate in a messaging session with a first device A 112(a) through an electronic network 110 (FIG. 1). In step 1016, second device B 112(b) receives a photo message 710 transmitted from the first device A 112(a), as discussed above in conjunction with step 928 of FIG. 9. In step 1020, device B 112(b) may display the photo data 722 and corresponding text message 718 from photo message 710 on a messaging display 216 of device B 112(b).

In step 1024, a second device user of device B 112(b) determines whether to send a response photo message 710 to device A 112(a). If the second device user of device B 112(b) determines to send a response photo message 710 to device A 112(a), then in step 1028, device B 112(b) may create and transmit a photo message 710 to device A 112(a) using the same or similar techniques as those discussed above in conjunction with steps 916-928 of the FIG. 9 embodiment. In step 1032, device B 112(b) waits for a response photo message 710 from device A 112(a). In step 1032, when a response photo message 710 from device A 112(a) is detected, then the FIG. 10 process may return to step 1016 to receive and display the new photo message 710 from device A 112(a). The FIG. 10 messaging session may thus continue with photo messages being exchanged between device A 112(a) and device B 112(b) until one or both of the devices 112 perform a log-off procedure to terminate the messaging session. The present invention thus provides a streamlined, efficient, and user-friendly mechanism for exchanging photo data 722 between network devices 112 to thereby support instant messaging communications.

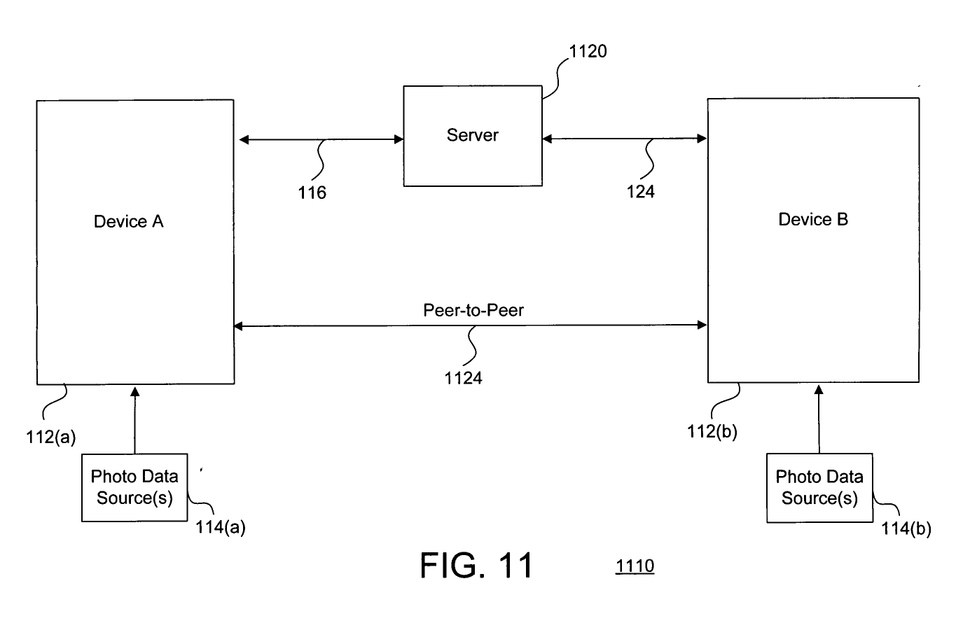

Referring now to FIG. 11, a block diagram illustrating a split transmission technique for a photo message 710 is shown, in accordance with one embodiment of the present invention. In the FIG. 11embodiment, the split transmission technique may utilize a device A 112(a), a device B 112(b), one or more photo data sources 114(a), one or more photo data sources 114(b), a server 1120, and a peer-to-peer link 1124. The FIG. 11 embodiment is presented for purposes of illustration, and in alternate embodiments, split transmission techniques may readily be performed using various components and configurations in addition to, or instead of, those discussed in conjunction with the FIG. 11 embodiment.

In the FIG. 11 embodiment, devices 112 may exchange photo messages 710 each containing a text message 718 and corresponding photo data 722 through path 116, server 1120, and path 124. However, in certain circumstances, especially when the data size of photo data 722 becomes relatively large, devices 112 may efficiently utilize the foregoing split transmission technique to exchange photo messages 710 by continuing to send the text messages 718 through server 1120, while simultaneously transmitting the corresponding photo data 722 directly between device A 112(a) and device B 112(b) via peer-to-peer link 1124 by utilizing appropriate peer-to-peer communications technology. In the FIG. 11embodiment, peer-to-peer link 1124 may therefore be advantageously implemented to facilitate the rapid and efficient transfer of photo data 710 and other high-volume data transmissions such as audio, graphics, and video information.

The invention has been explained above with reference to certain embodiments. Other embodiments will be apparent to those skilled in the art in light of this disclosure. For example, the present invention may readily be implemented using certain configurations and techniques other than those described in the specific embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for performing a messaging procedure in an electronic network, comprising:
a first device coupled to said electronic network for utilizing a first messaging program and a first messaging display to create a text message for said messaging procedure;
a photo data source configured to capture photo data when said first device is instructed to transmit said text message, said first messaging program automatically creating a photo message that includes said photo data and said text message, said messaging program transmitting said photo message over said electronic network; and
a second device coupled to said electronic network for utilizing a second messaging program to receive said photo message, said second device displaying said text message and said photo data upon a second messaging display.

2. The system of claim 1 wherein said first device and said second device are implemented as consumer-electronics entertainment devices that communicate through said electronic network.

3. The system of claim 2 wherein said consumer-electronics entertainment devices are configured to include a hard-disk-drive memory device storing one or more electronic gaming programs, said consumer-electronics entertainment device being further configured to include a broadband navigator and a network adapter for communicating over said electronic network.

4. The system of claim 1 wherein said electronic network includes an Internet network, said first device and said second device communicating via said Internet network.

5. The system of claim 1 wherein said first device and said second device transfer said text message over a network path through a network server, said first device and said second device transferring said photo data directly over said peer-to-peer link outside of said network path.

6. The system of claim 1 wherein said photo data source is implemented as an electronic camera device that communicates with said first device by utilizing at least one of a wireless and a hard-wired communication technique.

7. The system of claim 1wherein said photo message is alternately implemented to distribute at least one of audio data, graphics data, video data, and text data instead of said photo data.

8. The system of claim 1 wherein said second device performs a reciprocal messaging procedure to automatically create and send a return photo message to said first device.

9. The system of claim 1 wherein said photo message has a message header that includes sender information, receiver information, subject information, time/date information, and extended information.

10. The system of claim 1 wherein said photo data source provides said photo data to a first photo manager of said first device for including in said photo message.

11. The system of claim 1wherein said first device and said second device perform said messaging procedure during a messaging session in which multiple photo messages are exchanged, said first device and said second device storing said photo data and said text data from said multiple photo messages as messaging session data.

12. The system of claim 11 wherein at least one of said first device and said second device sequentially displays a photo series from said multiple photo messages as a slide show from said messaging session.

13. The system of claim 1 wherein said first messaging display and said second messaging display present similar representations of said photo message and one or more subsequent photo messages from said messaging procedure.

14. The system of claim 13 wherein a current one of said subsequent photo messages is inserted at the bottom of said first messaging display and said second messaging display, said first messaging display and said second messaging display scrolling-off one or more oldest photo messages to create presentation space for said current one of said subsequent photo messages.

15. The system of claim 1 wherein a first device user activates a “send message” icon on said first messaging display to instruct said first device to transmit said text message, said photo data source responsively capturing said photo data for creating said photo message.

16. The system of claim 1 wherein said photo data source is positioned to concurrently capture a facial image of a first device user of said first device when said text message is transmitted to said second device, said facial image enhancing communication capabilities of said messaging procedure.

17. The system of claim 1 wherein said first device supports a live preview mode that displays a live image from said photo data source on said first messaging display to thereby facilitate capturing said photo data by accurately aiming said photo data source.

18. The system of claim 1 wherein said photo message is utilized during an electronic conference by remote parties to exchange an image of visual subject matter that includes a drawing, a document, or a physical object.

19. The system of claim 18 wherein said messaging procedure economically facilitates said electronic conference by providing visual conferencing benefits with minimal system resource requirements for processing power, memory capacity, and communications bandwidth.

20. The system of claim 1 wherein said first device and said second device repeatedly exchange photo message communications in a bi-directional manner over said electronic network to implement an instant messaging procedure.

21. A method for performing a messaging procedure in an electronic network, comprising the steps of:
utilizing a first messaging program and a first messaging display of a first device in said electronic network to create a text message for said messaging procedure;
capturing photo data with a photo data source when said first device is instructed to transmit said text message, said first messaging program automatically creating a photo message that includes said photo data and said text message;
transmitting said photo message from said first electronic device over said electronic network; and
utilizing a second messaging program of a second device in said electronic network to receive said photo message, said second device displaying said text message and said photo data upon a second messaging display.

22. The method of claim 21 wherein said first device and said second device are implemented as consumer-electronics entertainment devices that communicate through said electronic network.

23. The method of claim 22 wherein said consumer-electronics entertainment devices are configured to include a hard-disk-drive memory device storing one or more electronic gaming programs, said consumer-electronics entertainment device being further configured to include a broadband navigator and a network adapter for communicating over said electronic network.

24. The method of claim 21 wherein said electronic network includes an Internet network, said first device and said second device communicating via said Internet network.

25. The method of claim 21 wherein said first device and said second device transfer said text message over a network path through a network server, said first device and said second device transferring said photo data directly over said peer-to-peer link outside of said network path.

26. The method of claim 21 wherein said photo data source is implemented as an electronic camera device that communicates with said first device by utilizing at least one of a wireless and a hard-wired communication technique.

27. The method of claim 21 wherein said photo message is alternately implemented to distribute at least one of audio data, graphics data, video data, and text data instead of said photo data.

28. The method of claim 21 wherein said second device performs a reciprocal messaging procedure to automatically create and send a return photo message to said first device.

29. The method of claim 21 wherein said photo message has a message header that includes sender information, receiver information, subject information, time/date information, and extended information.

30. The method of claim 21 wherein said photo data source provides said photo data to a first photo manager of said first device for including in said photo message.

31. The method of claim 21 wherein said first device and said second device perform said messaging procedure during a messaging session in which multiple photo messages are exchanged, said first device and said second device storing said photo data and said text data from said multiple photo messages as messaging session data.

32. The method of claim 31 wherein at least one of said first device and said second device sequentially displays a photo series from said multiple photo messages as a slide show from said messaging session.

33. The method of claim 21 wherein said first messaging display and said second messaging display present similar representations of said photo message and one or more subsequent photo messages from said messaging procedure.

34. The method of claim 33 wherein a current one of said subsequent photo messages is inserted at the bottom of said first messaging display and said second messaging display, said first messaging display and said second messaging display scrolling-off one or more oldest photo messages to create presentation space for said current one of said subsequent photo messages.

35. The method of claim 21 wherein a first device user activates a “send message” icon on said first messaging display to instruct said first device to transmit said text message, said photo data source responsively capturing said photo data for creating said photo message.

36. The method of claim 21 wherein said photo data source is positioned to concurrently capture a facial image of a first device user of said first device when said text message is transmitted to said second device, said facial image enhancing communication capabilities of said messaging procedure.

37. The method of claim 21 wherein said first device supports a live preview mode that displays a live image from said photo data source on said first messaging display to thereby facilitate capturing said photo data by accurately aiming said photo data source.

38. The method of claim 21 wherein said photo message is utilized during an electronic conference by remote parties to exchange an image of visual subject matter that includes a drawing, a document, or a physical object.

39. The method of claim 38 wherein said messaging procedure economically facilitates said electronic conference by providing visual conferencing benefits with minimal system resource requirements for processing power, memory capacity, and communications bandwidth.

40. The method of claim 21 wherein said first device and said second device repeatedly exchange photo message communications in a bi-directional manner over said electronic network to implement an instant messaging procedure.

41. A system for performing a messaging procedure in an electronic network, comprising:
means for creating a text message for said messaging procedure;
means for capturing photo data when said means for creating is instructed to transmit said text message, said means for creating automatically creating a photo message that includes said photo data and said text message;
means for transmitting said photo message over said electronic network;
means for receiving said photo message; and
means for displaying said text message and said photo data upon a messaging display.

42. A system for performing a messaging procedure in an electronic network, comprising:
a first device configured to automatically create a photo message that includes a text message and photo data that are contemporaneously created; and
a second device configured to receive and display said photo message upon a messaging display.

43. An electronic device for participating in a messaging procedure in an electronic network, comprising:
a messaging program that creates a text message for said messaging procedure; and
a photo data source configured to capture photo data when said electronic device is instructed to transmit said text message, said messaging program automatically creating a photo message that includes said photo data and said text message, said messaging program transmitting said photo message over said electronic network, said messaging program also receiving and displaying return text messages and corresponding return photo data from said electronic network upon a messaging display.
